(19) United States
(12) Patent Application Publication
(10) Pub. No.: US 2011/0088338 A1
(43) Pub. Date: Apr. 21, 2011

(54) CONSTRUCTION PANEL

(76) Inventors: Craig White, Bristol (GB); Timothy Mander, Bristol (GB)

(21) Appl. No.: 12/918,713

(22) PCT Filed: Jan. 30, 2009
(86) PCT No.: PCT/GB09/00283

§ 371 Date: Dec. 8, 2010

(30) Foreign Application Priority Data
Feb. 26, 2008 (GB) 0803489.4

(51) Int. Cl. E04C 2/18; E04C 2/16; E04C 2/10; B29C 33/38; B29C 43/18

(52) U.S. Cl. 52/146; 264/219; 264/129

(57) ABSTRACT

There is provided a construction element comprising a frame (5) and a plurality of cellulose bales (20), characterised in that the construction element further comprises at least one stabilising element (30) and in that the plurality of cellulose bales (20) is compressed. There is further provided a method of manufacture of such a construction element.

### FIELD OF THE INVENTION

The invention relates to the area of building construction, providing pre-fabricated panels for use in construction of a building. In particular, the invention relates to panels which include straw bales in their structure.

### BACKGROUND

Over recent years, there has been increasing focus on the impact of construction projects on the global environment, in terms of the methods and materials used in construction and in terms of the efficiency of the buildings created. For example, improved thermal insulation to minimise heat energy loss from buildings is widely recognised as essential to achieving government targets for greenhouse gas emission reductions (DTI Energy White Paper—Our energy future, creating a low carbon economy, 2003). The United Kingdom government has set the target for all new housing in the UK to be zero carbon dioxide emitting by the year 2016. The means by which this will be regulated is called the Code for Sustainable Homes, zero carbon is described as Code level 6. The thermal performance of housing in the UK lags behind European standards. To bring a current cavity wall system up to the thermal standards required for zero carbon housing, using conventional mineral wool insulation, the wall would need to be 543 mm thick (blockwork inner leaf 140 mm, insulation 300 mm and brickwork outer leaf 103 mm). Thinner wall constructions are available but the type of insulation used, such as phenolic foams or expanded polystyrene foamed glass, all have detrimental environmental effects and the amount of CO₂ emitted through their manufacture is high.

There has been a focus on using natural or recycled materials in construction, so as to minimise chemical pollution and the carbon footprint. For example, fibrous recycled newspaper, or other recycled materials, can be used as a cavity wall insulation. In addition, materials such as straw bales can be used to form the walls of a building, providing walls which are themselves made from a material which is inherently insulating. Though straw bales have been used for over 100 years to construct buildings, their use has largely remained on the self-build periphery of the construction industry (Jones, Straw Bale Handbook, 2001). However there is now an increasing interest in using such natural products more routinely in the construction industry.

The building industry is moving more towards more prefabrication off site which ensures a rapid, good quality, construction. There is great interest in developing these modern methods of construction. (MMC).

The building industry is a hugely significant market. In the United Kingdom alone, the market in building cladding systems, including SIPS (Structural Insulated Panels), masonry and other systems, can be estimated at between £3-4 billion pounds per annum (Monthly Statistics of Building Materials and Components, 334, HMSO, 2003).

### SUMMARY OF INVENTION

According to a first aspect of the invention there is provided a construction element comprising a frame and a plurality of cellulose bales, characterised in that the construction element further comprises at least one stabilising element and in that the plurality of cellulose bales is compressed.

The term “compressed”, as used above, indicates that the cellulose bales are compressed during the manufacture of the construction element and are subsequently maintained in the compressed condition after the manufacture is complete. This indicates an additional compression over the compression of material which is already achieved during the preparation of the bale and is also greater than the compression that would be achieved by the effects of gravity as layers of bales are stacked on top of one another.

Preferably, the construction element comprises at least one tensioning element which, in combination with the frame, serves to maintain the cellulose bales in the compressed condition.

The cellulose bales preferably comprise straw. The straw may be, by way of non-limiting example, barley, oat, rice, corn, maize, rye, triticale or wheat straw, miscanthus, rape straw or reed canary grass. A mixture of any of these materials may be used. Preferably, at least one of the cellulose bales is a straw bale having a starting density of between 120-150 kg/m³, preferably about 120 kg/m³. The term “starting density” indicates the density of the straw bale prior to the compression carried out during manufacture of the construction element.

Advantageously, a construction element according to the invention provides a modular system for creating a building using cellulosic material as a cladding and insulating material. In addition, since cereal crops sequester carbon dioxide during their growth, the use of straw within a construction element and preserving it for the life of a building offers a means of reducing carbon dioxide levels. A typical 3.2×3 m panel according to the invention has the atmospheric equivalent of 595 kg of CO₂ locked inside it. In addition, the inclusion of compression of the straw and of the stabilising element(s) results in a construction element which not only provides good insulation but is also stable against flexing as the result of weather forces such as wind.

Preferably, each of the cellulose bales has a starting moisture content of between 10-20%, more preferably less than about 15%. More preferably, a similar range of moisture content is maintained after each bale is incorporated into a construction element according to the invention.

Each of the cellulose bales preferably comprises two sides having cut cellulose ends. Straw bales are typically constructed with each stem of straw being bent double, with the folded over end being located one face of the bale and the two cut ends of each step being exposed on the opposite face of the bale. The term “two sides having cut cellulose ends” indicates that a bale for use in the invention is sliced through on the side of the bale where the folded over ends are located, such that there are cut ends of the stems of straw on two opposing faces of the bale.

In a preferred embodiment, the frame is at least partly formed from wood, preferably an engineered wood product such as that supplied by Eurban Construction (London, UK).

Preferably, the construction element further comprises at least one bracing element, for example placed across a corner of the frame to keep the corner at a right angle. Such bracing elements may be included across the corners of the frame on one or both sides of the construction element.

The frame may be formed in any desired shape, but will typically be a rectangle. Dimensions of the frame may be varied according to the use to which the construction element is to be put.

Preferably, the construction element according to the invention is formed as a panel. It may also further comprise a render, for example a lime-based render.

Therefore, in a most preferred embodiment, the construction element is a panel comprising a rectangular frame which surrounds a “wall” of straw bales, layered in several courses, for example in a running bond arrangement. The frame maintains the bales in a compressed condition. The bales are orientated in a direction such that the stems of the straw run from the front to the back of the panel, with cut ends of the straw stems directed outwardly from the panel. Several stabilising elements in the form of rods are positioned by insertion through the bales in a direction substantially perpendicular to the orientation of the straw stems and across the longest width of the panel, within a single layer of bales. Such stabilising elements may also be inserted along the length of a panel, through one or more layers of bales. In a further addition, stabilising elements could be inserted in a diagonal direction, relative to the height, width or depth of the construction element.

Bracing elements are placed across the corners of the frame to increase the stiffness of the structure and to maintain the shape and dimensions of the rectangle. A render is applied to the cut ends of the straw stems and extends across the whole area of the frame, such that the final product is a pre-fabricated construction panel, ready for use in the construction of a building.

The construction element according to the invention has a U-value of about 0.15 W/m²K or less, preferably about 0.13 W/m²K or less, more preferably about 0.1 W/m²K or less. Advantageously, this is significantly better that the value required for new buildings in the United Kingdom, 0.35 W/m²K.

Preferably, the construction element according to the invention comprises means of engaging with at least one other construction element. For example, this may take the form of a lip and groove arrangement such that two construction elements according to the invention can interengage. Alternatively or additionally, the construction element according to the invention may comprise means of engaging with at least one other construction element not according to the invention, such as a conventional wall or floor structure. The means of engaging may be provided by an additional feature such as a metal plate including apertures through which the construction element may be fixed to another structure. Such means of engaging could be readily employed by the skilled person without the need for inventive activity.

The construction element may comprise additional features such as a frame for a window or a door. Other variations of the overall appearance of the construction element will be readily apparent to the skilled person.

The dimensions of the side of the frame which is to form the base or lower side of the element may be adapted, relative to the dimensions of the rest of the frame, to promote flow of water away from the construction element, in the event that rain or another water source contacts the exterior surfaces of the construction element. Further structural features such as one or more sills and/or channels may be added to promote flow of water away from the construction element.

According to a second aspect of the invention, there is provided a structure comprising at least two construction elements according to the first aspect of the invention. Preferably, at least one construction element is engaged with at least one other construction element. Such a structure might be an internal or external wall, or a building.

According to a third aspect of the invention there is provided a method of manufacture of a construction element, the method comprising the steps of:
a) forming a frame having an opening;
b) arranging at least one cellulose bale within the frame;
c) compressing each at least one cellulose bale; and
d) completing the frame by closing the opening, such that each at least one cellulose bale is maintained in a compressed state.

Preferably, the method further comprises the step of inserting at least one stabilising element into at least one cellulose bale. The method may also comprise including at least one tensioning element in the construction element, each at least one tensioning element serving to maintain the cellulose bales in the compressed condition. For example, a tensioning element may provide a link between opposing sides of a rectangular frame.

By way of example, the construction of a rectangular panel may begin by assembly of three sides of the frame, leaving an opening on the fourth side. Bales are then lowered into the frame and layered, for example in a running bond arrangement. As bales are added, stabilising elements in the form of rods are inserted through the bales, to link one layer of bales to the next layer and to prevent layers of bales sliding over one another. Once the layers of bales have reached the top of the frame, the bales are compressed. Additional stabilising elements are added as necessary and the final side of the frame is added and fixed to the rest of the frame, such that the bales within the frame are maintained in the compressed state. A tensioning element may be included, to assist with this.

The number of layers of bales included in a construction element according to the invention is determined by the dimensions of the frame. The number of layers may be as low as one; there is no upper limit to the number of layers which may be included. By way of non-limiting example, the number of layers may be in the range 5-30, or 7-15.

The method may further comprise the step of attaching at least one bracing element to the frame, for example across a corner of the frame to provide additional stiffness and to ensure that the shape and dimensions of the frame are maintained. The method preferably further comprises the step of applying a render to an exposed face of at least one cellulose bale. For example, where the construction element is a panel, render may be applied across all exposed straw such that the end product is a panel with both large faces fully rendered. Advantageously, the use of bales which have been cut such that cut ends of the straw stalks are exposed improved the binding of render to the surface of the straw bales.

At least one cellulose bale used in the method may comprise straw. The straw may be, by way of non-limiting example, barley, oat, rice, corn, maize, rye, triticale or wheat straw, miscanthus, rape straw or reed canary grass. A mixture of any of these materials may be used. Preferably, at least one of the cellulose bales is a straw bale having a starting density of between 120-150 kg/m³, preferably about 120 kg/m³. The term “starting density” indicates the density of the straw bale prior to the compression carried out during manufacture of the construction element.

Each cellulose bale preferably has a starting moisture content of between 10-20%, more preferably less than about 15%. More preferably, a similar range of moisture content is maintained after each bale if incorporated into a construction element. Each of the cellulose bales may comprise two sides having cut cellulose ends, this term having the same meaning as explained above.

Preferably, at least part of the frame is formed from wood, preferably an engineered wood product such as that supplied by Eurban Construction (London, UK).

Preferably, the method according to the third aspect of the invention is used to manufacture a construction element according to the first aspect of the invention.

The invention represents an innovative, high quality, external cladding system for buildings using straw bales, an agricultural by-product, together with timber and hydraulic lime. Advantageously, the construction element according to the invention may be manufactured away from the final building construction site, so that the elements are provided to the construction site in a pre-fabricated form, reducing delays and construction project duration. The cladding system is suitable for a wide range of low and medium rise buildings. Development of this technology will provide building elements using resource efficient renewable insulation materials that are capable of storing, throughout their life cycle, significant quantities of CO₂ sequestrated from the atmosphere. Straw bales are locally available at most locations in the UK, non-toxic and easily recycled, as animal bedding, or disposed at the end of their life cycle. The construction elements of the invention can be constructed locally at “flying factories”, given the simple nature of the construction and the local availability of straw bales; such local construction further minimises the impact of a building project on the environment, by reducing the need to transport building components over large distances. Using plant fibre materials will replace other currently widely used materials, such as rigid polyurethane and mineral fibre insulation products, which rely on essentially non-renewable resources and often involve industrial processes that have potential to damage the environment (e.g. fossil fuel extraction), as well as reduce the quantity of waste insulation materials sent to landfill on end use.

### DESCRIPTION OF THE FIGURES

Embodiments of the invention will now be described, by way of example only, with reference to the accompanying FIGS. 1-7 in which:

FIG. 1 shows a side view of a construction element according to the invention without render;

FIG. 2A shows the arrangement of bent over straw stems included in a standard straw bale and FIG. 2B shows the arrangement of straw stems having been cut along the line B-B of FIG. 2A, as used in bales included in a construction element according to the invention;

FIG. 3 is a picture of a rendered construction element according to the invention;

FIG. 4 shows a cross-sectional view, in the direction C-C in FIG. 1, of the top portion of a construction element according to the invention;

FIG. 5 shows moisture content levels of straw bales within a panel exposed to UK weather conditions over a six month period;

FIG. 6 shows the shear loads which can be placed through a construction element according to the invention before the structure of unreinforced and reinforced embodiments of the invention fails; and

FIG. 7 shows the displacement of parts of a non-inventive construction element (A) and a construction element according to the invention (B) as the result of wind load.

### DETAILED DESCRIPTION

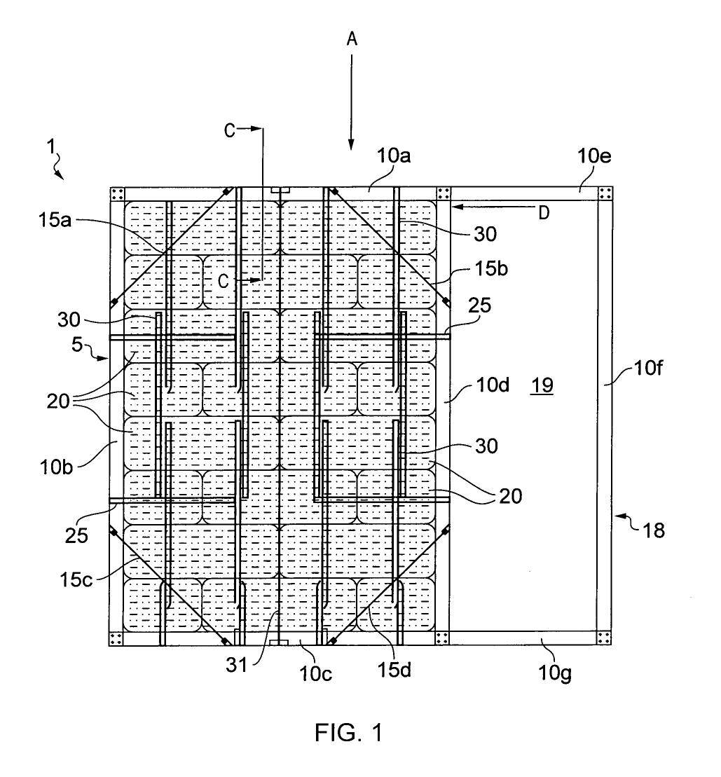

FIG. 1 shows a building panel 1 having a timber frame 5, with four sides, 10a, 10b, 10c and 10d. The frame is braced with corner braces 15a, 15b, 15c and 15d which serve to stiffen the structure and maintain the corners at an angle of 90°. A secondary frame 18 formed by secondary frame sides 10e, 10f and 10g is also shown; these frame sides, along with side 10d of the frame 5, form aperture 19. Sides 10e and 10g may, in fact, be extensions of sides 10a and 10c, respectively, such that, for example, elements 10a and 10e are a single, unitary element. The secondary frame may be used as, for example, a window frame or a door frame, with the aperture 19 being covered by a window or a door, respectively.

A plurality of straw bales 20 are positioned in eight layers within the frame, in a running bond arrangement. Timber dowels 25 are inserted through the bales within a single layer, to hold them in the correct position. Dowels 30 may also be inserted through the layers of bales, to hold the bales in place and to strengthen and stiffen the structure. During construction of the panel the bales are compressed in the direction of the arrow A. The panels are maintained in the compressed state by the frame surrounding the bales and vertical tensioning elements 31, one on either side of the panel 1. These serve to maintain the compression of the bales by holding sides 10a and 10c in position. A render 32 (not shown in FIG. 1) is applied to the external straw faces of the panel.

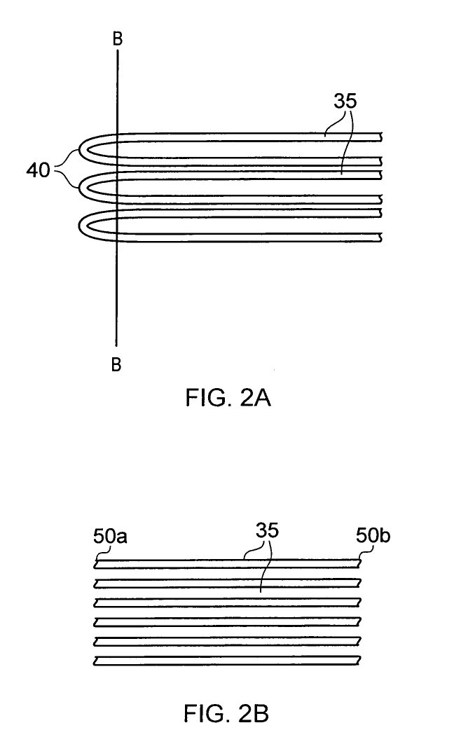

The panel of FIG. 1 is manufactured by the following method. Firstly, straw bales 20 are prepared by slicing them on one side, such that there are cut straw stalks on two faces of each bale. Straw stems 35 bent in the middle at 40 are shown in FIG. 2A, in the layered arrangement as included in a standard straw bale. The straw stalks are cut along the line B-B to provide straw stalks having two cut ends 50a and 50b; bales cut in this way are used to form the panel 1.

A timber frame 5 is prepared by joining sides 10b, 10c and 10d into a square U-shape, with corner braces 15c and 15d added to hold the frame 5 in a right-angled configuration. The frame is positioned with side 10d forming the base and sides 10b and 10c extending vertically. Seven layers of straw bales 20 are arranged within the frame in a running bond pattern, with timber horizontal dowels 25 and vertical dowels 30 inserted through the bales as the layers are added, to hold the bales in position and to add strength and stiffness to the structure. The bales 20 are orientated such that the cut straw stalk ends 50a and 50b form the external faces of the panel.

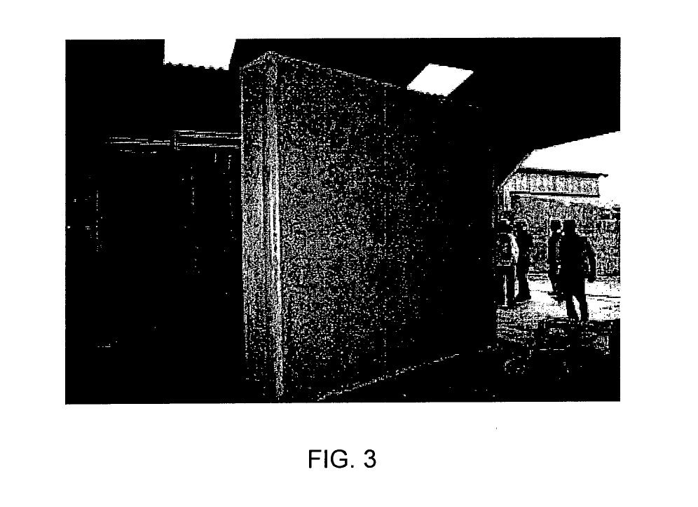

Once the layers of bales are in position, the bales are compressed in the direction of the arrow A in FIG. 1. This can be achieved, for example, using external threaded steel bars to pull down the top timber beam, though alternative systems such as meshes and/or plastic strapping are also used. Vertical tensioning elements 31, one on either side of the panel 1, serve to maintain the compression of the bales by holding sides 10a and 10c in position relative to one another. The tensioning elements can also be used to assist with, or to carry out, the compression of the bales as the panel is assembled. Corner braces 15a and 15b are added to ensure that the dimensions and shape of the frame 5 is maintained. A render 32 (not shown in FIG. 1) is applied to the straw bale faces of the panel. The finished product is shown in FIG. 3.

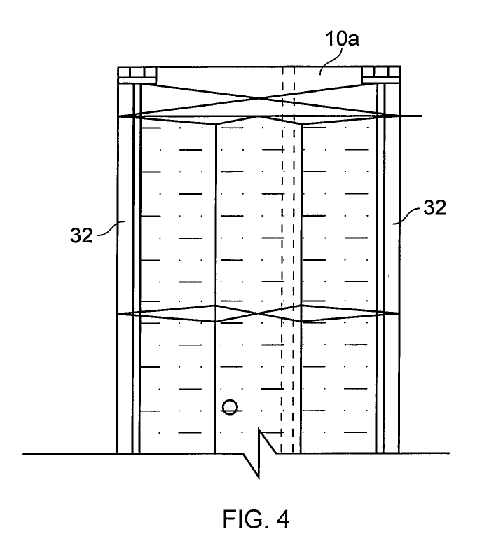

FIG. 4 is a cross-sectional view along the line C-C in FIG. 1, showing detail of the head plate, or top section 10a of the frame 5. The render 32 can also be seen in this Figure.

Typically, the solid panels measure 3 metres high by 3.2 metres wide, though a range of modular sizes, including window and door openings, as shown in FIG. 1, are available. Panels are secured directly to the primary structural frame of the building using steel ties and fixings, removing the need for secondary members such as purlins and side rails.

The outer timber frame, together with bracing elements, provides the main structural framework for the cladding panel. However, the rendering layers also make a significant contribution to stiffness. Straw bales provide excellent insulation. Building Regulation (Part L—Conservation of Fuel and Power) requirements (United Kingdom) for thermal insulation have become increasingly stringent in recent years. A standard size 450 mm thick bale provides a U value around 0.1 W/m²K, exceeding current and likely future minimum performance requirements.

Panels may be 490 mm thick, based on a 430 mm thick standard straw bale width. However, thinner panels can be prepared by use of bales produced specifically for use with the invention, or by slicing down of standard bales.

Exposure tests

It is important that the bales 20 remain at moisture content below which biological decay will occur, typically around 25%. It is preferred to maintain the moisture content at below 20%. The lime coatings used as render protect the bales from direct weathering but also allow water vapour to escape as part of a breathing wall system.

Panels were exposed to UK weather conditions at a test site over a period of 6 months. During this time, there was approximately 0.5 m of rainfall. The testing panels included sensors which measured the temperature and humidity of the straw within each panel.

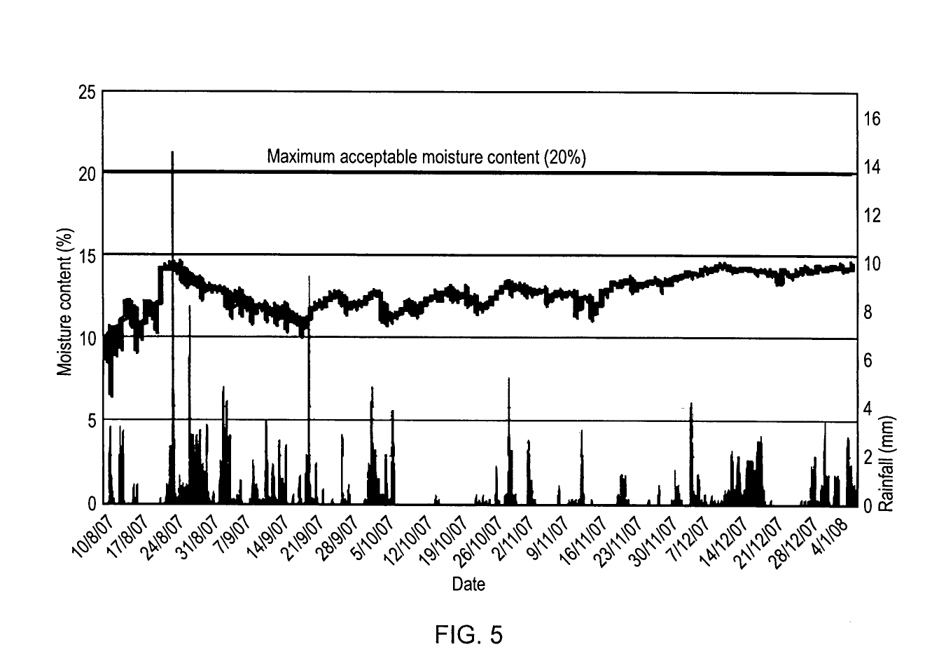

FIG. 5 shows the moisture content of the panel in the area just beneath the render surface at the bottom of the panel. This is the most sensitive part of the panel, since maximum water flow occurs here. Moisture levels were monitored from the time when the wet render was first applied. An initial moisture “shock” is clearly observed over the first two weeks. The lime render used in the panel is formulated to be “breathable” and strong, taking up to 6 months to fully carbonate. FIG. 5 shows that, over a 6 month period, the moisture content of the panel settles to just below 15%, well below the preferred upper threshold of 20%.

Racking tests

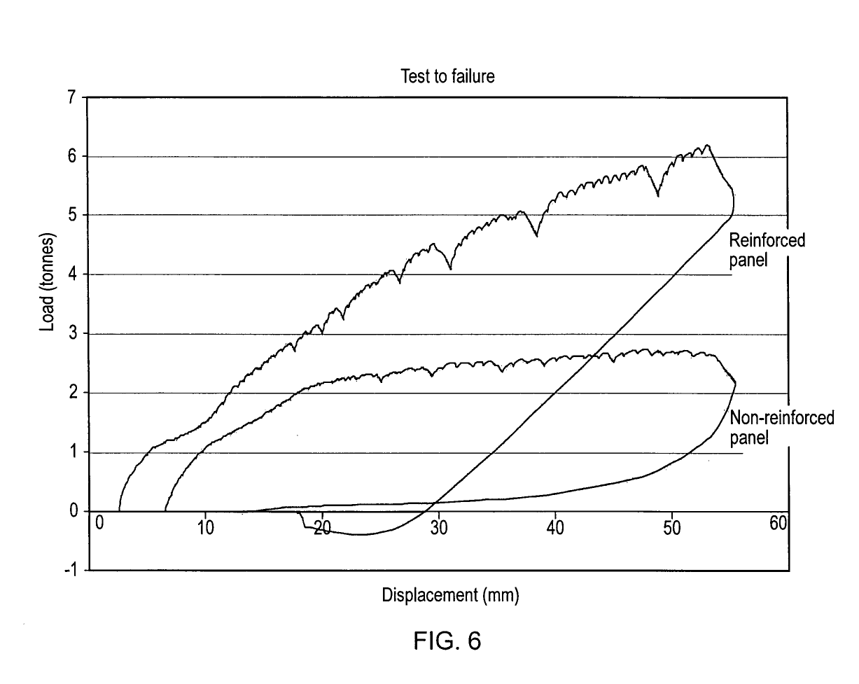

The strength of the panels was tested by fixing the bottom side of a panel (element 10c of FIG. 1) to the floor and applying a gradually increasing force along the direction of arrow D to the top portion of the frame. Panels including corner braces 15 were compared to panels not including such braces and the results from one such test are shown in FIG. 6. This shows that the inclusion of the corner braces significantly increases the amount of load which can be applied before failure of the structure occurs.

Wind load tests

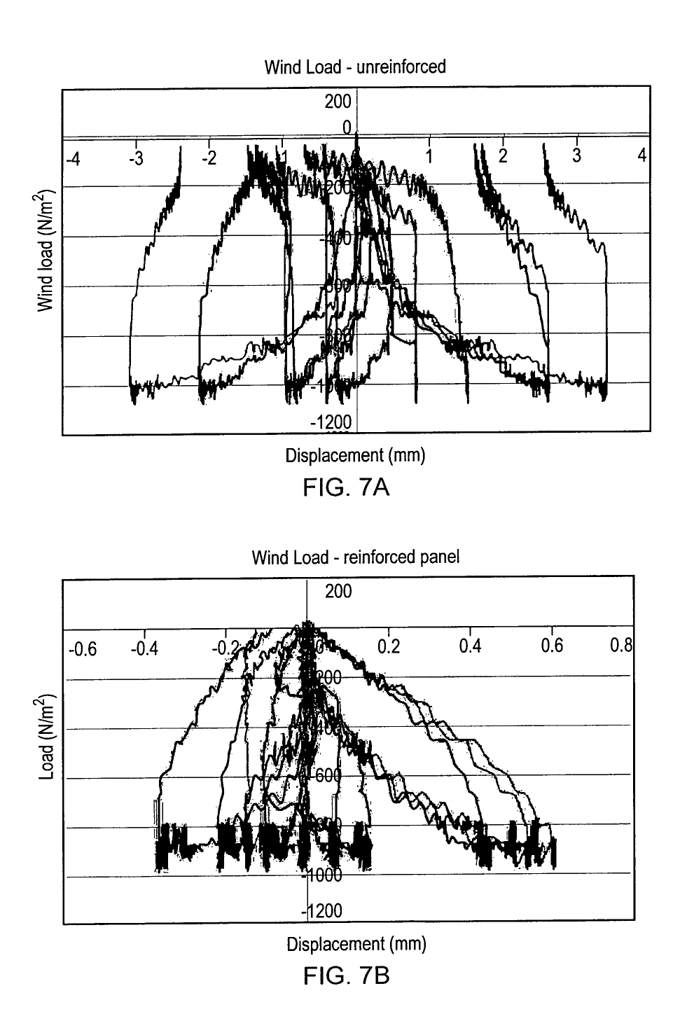

The amount of displacement of panels when horizontal forces against the rendered face of the panel are applied (to simulate the effects of wind) was tested in panels including corner braces 15 and timber dowels 25 and in panels not having these features. The results are shown in FIG. 7, with FIG. 7A showing displacement for non-inventive unreinforced panels and FIG. 7B showing displacement for reinforced panels according to the invention. Each trace on the Figure shows measurements taken from a single strain gauge located at one of several different positions on one or the other face of the panel. The Figure clearly shows the benefits of including the reinforcements; the magnitude of displacement is much greater in the unreinforced panel compared to the reinforced panel. In addition, in the unreinforced panel does not return to its initial undisplaced position after the force is reduced, whereas the reinforced panel returns to the zero displacement position.

1-26. (canceled)

27. A construction panel for use in construction of a building, the construction panel comprising a wooden frame which surrounds a plurality of cellulose bales which are formed into a wall, wherein the construction panel further comprises at least one stabilizing element and wherein the plurality of cellulose bales is compressed.

28. A construction panel according to claim 27 further comprising at least one tensioning element.

29. A construction panel according to claim 27 wherein at least one of the cellulose bales comprises straw.

30. A construction panel according to claim 27 wherein at least one of the cellulose bales is a straw bale having a starting density of between 120-150 kg/m³.

31. A construction panel according to claim 27 wherein at least one of the cellulose bales has a starting moisture content of between 10-20%.

32. A construction panel according to claim 27 wherein at least one of the cellulose bales comprises two sides having cut cellulose ends.

33. A construction panel according to claim 27, further comprising at least one bracing element.

34. A construction panel according to claim 27 further comprising a render.

35. A construction panel according to claim 34 having a U-value of about 0.15 W/m²K or less.

36. A construction panel according to claim 27 comprising means of engaging with at least one other construction element.

37. Structure comprising at least two construction panels according to claim 27.

38. Structure according to claim 37 wherein at least one construction panel is engaged with at least one other construction panel.

39. Structure according to claim 37 which is a building.

40. Method of manufacturing a construction panel according to claim 27, the method comprising the steps of:
(a) forming a frame having an opening;
(b) arranging a plurality of cellulose bales within the frame;
(c) compressing the cellulose bales; and
(d) completing the frame by closing the opening, such that each cellulose bale is maintained in a compressed state.

41. Method according to claim 40 wherein the method further comprises the step of inserting at least one stabilizing element into at least one cellulose bale.

42. Method according to claim 40 wherein the method further comprises the step of attaching at least one bracing element to the frame.

43. Method according to claim 40 wherein the method further comprises the step of applying a render to an exposed face of at least one cellulose bale.

44. Method according to claim 40 wherein the cellulose bale comprises straw.

45. Method according to claim 40 wherein at least one cellulose bale is a straw bale having a starting density of between 120-150 kg/m³.

46. Method according to claim 40 wherein at least one cellulose bale has a starting moisture content of between 10-20%.

47. Method according to claim 40 wherein at least one cellulose bale comprises two sides having cut cellulose ends.
